(19) United States
(12) Patent Application Publication
(10) Pub. No.: US 2005/0248225 A1
(43) Pub. Date: Nov. 10, 2005

(54) Direct drive for a cylinder

(76) Inventors: Andreas Krause, Erlangen (DE); Helmut Liepold, Gremsdorf (DE); Dieter Weber, Forchheim (DE)

Correspondence Address: Andreas Grubert;Baker Botts, L.L.P., One Shell Plaza, 910 Louisiana, Houston, TX, 77002-4995, US

(21) Appl. No.: 11/115,549

(22) Filed: Apr. 27, 2005

Related U.S. Application Data
(63) Continuation of application No. PCT/DE03/03565, filed on Oct. 27, 2003.

(30) Foreign Application Priority Data
Nov. 8, 2002 (DE) 10252110.7

(51) Int. Cl. H02K 9/00; H02K 7/08

(52) U.S. Cl. 310/90; 310/89; 101/216; 310/61

(57) ABSTRACT

A direct drive (21) for a cylinder (1) comprises a hollow shaft (2). The direct drive comprises a drive housing (7) in which at least one rotor device (9) and at least one stator device (11) are arranged. According to the invention, the stator device (11) is connected to the drive housing (7), auxiliary substances and/or operating substances such as oil, coolant or vapour are supplied to the cylinder (1) through the hollow shaft, the hollow shaft (2) is guided through the drive housing (7) preferably without bearings, and the rotor device (9) is directly connected to the hollow shaft (2). The inventive drive (21) is especially maintenance-free and compact and especially used for a rotating cylinder (1) in the paper industry, without gearboxes and clutches, and with direct supply or discharge of auxiliary substances and/or operating substances. The rotor device (9) at least partially surrounds the hollow shaft (2).

### CROSS REFERENCE TO RELATED APPLICATION

This application is a continuation of copending International Application No. PCT/DE03/03565 filed Oct. 27, 2003 which designates the United States, and claims priority to German application no. 102 52 110.7 filed Nov. 8, 2002.

### TECHNICAL FIELD OF THE INVENTION

This invention relates to a direct drive for a cylinder with a hollow shaft, the direct drive having a drive housing, inside which are arranged at least one rotor device and at least one stator device, the stator device being connected to the drive housing.

### DESCRIPTION OF THE RELATED ART

In the basic materials industry, material webs, which may consist preferably of paper or else of plastic, aluminum or similar materials, are moved or processed with the aid of cylinders. Preferably cylinders of this type are designed as rotating rollers. At the present time, cylinders of this type, such are used, for example, in the paper industry, are driven by means of a motor, the motor force being supplied to the cylinder with the aid of a gear, a coupling and a cardan shaft via a gearwheel mounted about a connection piece. This gearwheel is, as a rule, part of a gear which drives the cylinder.

Known drive concepts require a relatively large amount of space, particularly because of the use of coupling devices, and are susceptible to faults, above all, when employed in the paper industry.

The object on which the invention is based is to provide a device of the type initially described which avoids the disadvantages mentioned.

### SUMMARY OF THE INVENTION

According to the invention, this object is achieved in that the rotor device of the direct drive is connected directly to the hollow shaft.

Advantageously, the hollow shaft is led, free of bearings, through the drive housing.

To increase operating reliability, however, it may be expedient for the hollow shaft to be mounted preferably in the drive housing.

Advantageously, the drive housing is connected to a frame element by means of a supporting element. Further space can thereby be saved.

Advantageously, the drive housing is connected directly to the frame element. This embodiment makes it possible, in particular, to arrange drives according to the invention and the cylinders driven by them so as preferably to be stacked one above the other.

For space-saving reasons, it is particularly expedient if the rotor device at least partially surrounds the hollow shaft.

For reasons of robustness and of the saving of space and of material, it is particularly expedient to connect the stator device directly to the drive housing.

Particularly in the paper industry, it is particularly advantageous if the axis of the hollow shaft coincides with the axis of the cylinder.

Advantageously, the hollow shaft is designed in such a way that auxiliaries and/or fuels, such as, for example, oil or steam, are supplied to the cylinder through the interior of the hollow shaft.

Advantageously, the hollow shaft is designed in such a way that auxiliaries and/or fuels are discharged from the cylinder through the interior of the hollow shaft.

The last three embodiments of the invention listed are extremely advantageous, above all, when the driven cylinder is a drying drum, a roller or a press device.

In order to save energy, it is particularly expedient to design the hollow shaft in such a way that the direct drive is cooled by means of the auxiliaries and/or fuels to be supplied to the cylinder.

Advantageously, the hollow shaft is designed in such a way that the direct drive is preheated by means of the auxiliaries and/or fuels to be supplied to the cylinder. Thus, the direct drive can be brought quickly or cost-effectively to operating temperature.

Advantageously, the direct drive has no bearing.

### BRIEF DESCRIPTION OF THE DRAWINGS

Further advantages and exemplary embodiments of the invention are explained with reference to the accompanying drawings in which:

FIG. 1 shows a direct drive with a supporting element,

FIG. 2 shows a direct drive, the drive housing of which is connected directly to a frame element,

FIG. 3 shows a drying cylinder with a direct drive,

FIG. 4 shows an arrangement, provided for the paper industry, of cylinders with a direct drive,

FIG. 5 shows a further arrangement, provided for the paper industry, of cylinders with a direct drive.

### DETAILED DESCRIPTION OF THE PREFERRED EMBODIMENTS

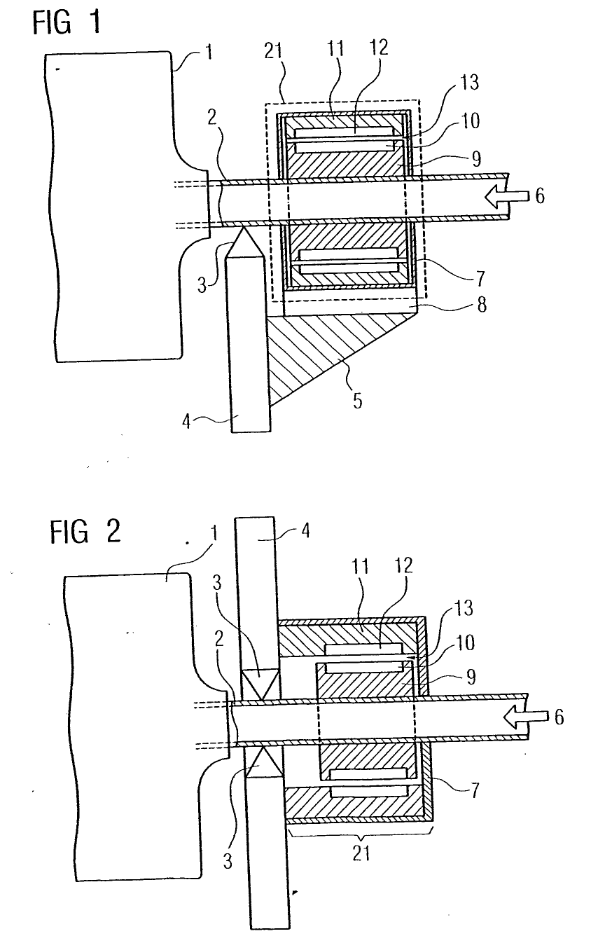

FIG. 1 shows a direct drive 21 for a cylinder 1. A hollow shaft 2 in this case coincides at least partially with the cylinder axis. The cylinder 1 is in this case illustrated in the drawing only as a partial outline. A bearing device 3 arranged on a frame element 4 serves for holding the cylinder 1 by means of the hollow shaft 2.

The hollow shaft 2 is connected fixedly to the cylinder 1 and performs preferably three functions:
1. Mounting of the cylinder 1 in conjunction with the bearing device 3,
2. Drive or rotation of the cylinder 1 with the aid of the drive device 21, and
3. Supply and/or discharge 6 of auxiliaries or fuels into and/or out of the cylinder 1.

With regard to the supply and/or discharge 6 of auxiliaries or fuels, auxiliaries and/or fuels, such as oil, water, steam or air, can be supplied to the cylinder and/or the pressure of the cylinder can be regulated. Fuels supplied may also be hydraulic oil or coolant. Steam is supplied, for example, when the driven cylinder is a drying cylinder for paper.

The hollow shaft 2 is preferably designed in such a way that auxiliaries and/or fuels can be discharged from the cylinder 1 through the interior of the hollow shaft 2.

Since auxiliaries and/or fuels are supplied or discharged through the hollow shaft 2, the cylinder can be pumped up or emptied in a controlled manner. Pumping up or emptying can also take place in a controlled manner for one or more segments of the cylinder.

The housing 7 of the drive device 21 lies on a supporting element 5 which is fastened to the frame element 4. In this case, one or more connecting elements 8 may be located between the drive housing 7 and the supporting element 5. The frame element 4 carries both the weight of the cylinder 1 and the weight of the drive device 21.

In addition to the housing 7, further components of the drive device 21 are the rotor device 9 and the stator device 11. The stator device 11 is preferably connected directly to the drive housing 7. However, an indirect connection to the drive housing 7 is also possible. The rotor device 9 is seated on the hollow shaft 2 and surrounds the latter at least partially. The drive device 21 is preferably slipped onto the hollow shaft 2 in this way.

The rotor device 9 has rotor windings 10. The stator device 11 has stator windings 12. An air gap 13 is located between the stator device 11 having the stator windings 12 and the rotor device 9 having the rotor windings 10.

FIG. 2 shows a direct drive 21 according to the invention which is fastened directly to the machine frame 4. The cylinder 1 with the hollow shaft 2 is mounted in the frame element 4 by means of the bearing devices 3. The actual drive device 21 is delimited by its housing 7. The housing 7 is designed to be virtually airtight, and therefore the drive device operates particularly free of wear and independently of faults. The drive device 21 is preferably designed without additional bearing devices for the shaft 2. Thus, lubricants may as far as possible be dispensed with. Lubricants would seep away undesirably particularly at the operating temperatures conventional in the paper industry.

As is also apparent from the drawing, the frame element 4 may form at least partially a closure of the housing 7. The drive housing 7 and the frame element 4 then surround the rotor device 9 and the stator device 11. Such a design of the drive device 21 is particularly temperature-resistant, this being of great importance particularly in the paper industry, since motor surfaces are otherwise exposed here to temperatures of around or above 100° C.

Moreover, the drive surface is protected in this way against high ambient air humidity.

The functions of the hollow shaft 2 have already been described in connection with FIG. 1. What must be emphasized particularly in this case, in connection with FIG. 2, is the axial supply of auxiliaries and fuels required in the roller or in the cylinder 1 by means of the hollow shaft 2.

The hollow shaft 2 is at least partially surrounded by the rotor device 9 having the rotor windings 10, the rotor device 9 preferably being connected directly to the hollow shaft 2. The stator device 11 having the stator windings 12 is connected directly to the drive housing 7 and/or to the frame element 4. While the rotor 9 is connected fixedly to the hollow shaft 2, the stator 11, in conjunction with the housing 7, is slipped preferably in the form of a pot over the rotor 9 and preferably in the closure of the hollow shaft 2, the housing 7 preferably being closed off by means of the frame element 4. Preferably, in this case, reducing sleeves, not illustrated in any more detail in the drawing, are used. The rotor 9 and the stator 11 are separated by means of an air gap 13. The air gap 13 ensures that no undesirable vibrations or oscillations are transmitted.

The closure, depicted on the right in FIG. 1 and FIG. 2, of the hollow shaft 2 and the design of the supply and/or discharge 6 of auxiliaries or fuels are illustrated merely diagrammatically.

The supply and/or discharge 6 of auxiliaries or fuels may be utilized, for example, in order to cool or to heat the direct drive 21 during operation. For example, by the supply of steam, the direct drive 21 is heated and reaches its operating temperature more quickly. The supply and/or discharge of auxiliaries or fuels can thus be utilized for preheating the direct drive 21.

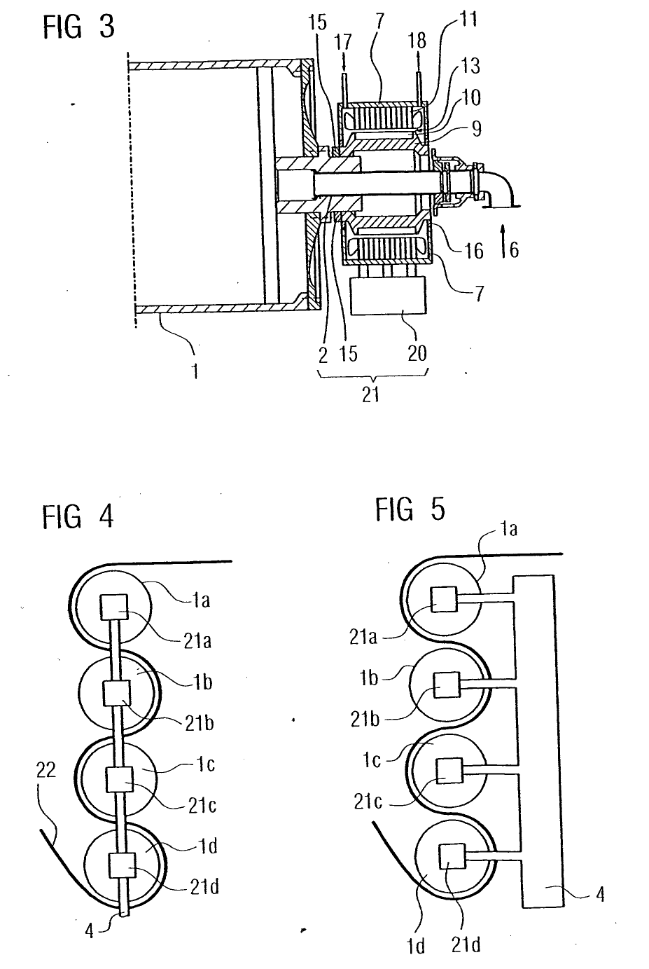

FIG. 3 shows a drying cylinder 1 with a hollow shaft motor 21 in the form of a direct drive. The hollow shaft 2 of the cylinder 1 is in this case mounted with the aid of shaft bearings 15. The direct drive 21 is fastened on a substructure element 20, if appropriate with the aid of fastening elements. The supply and/or discharge 6 of auxiliaries or fuels into and/or out of the drying cylinder 1 become possible via the hollow shaft 2.

The drive device 21 has a housing 7 which is preferably designed with seals 16. As in the exemplary embodiments shown in FIG. 1 and FIG. 2, a rotor device 9 having the rotor windings 10 and a stator device 11 having the stator windings 12 are arranged inside the housing 7.

As in the exemplary embodiments of the invention which are shown in FIG. 1 and FIG. 2, the cooling of the drive device 21 is also possible by means of fuels which are conducted through the hollow shaft 2. Furthermore, or alternatively to this, in the exemplary embodiment shown in FIG. 3, at least one coolant line 17 and one coolant discharge line 18 are additionally provided, if appropriate, in the drive device 21.

The air gap 13 as far as possible prevents the transmission of undesirable vibrations or oscillations between the rotor 9 and the stator 11. It is conceivable to introduce into the gap 13 materials which prevent or further reduce the transmission of undesirable vibrations or oscillations.

It is possible to mount the hollow shaft 2 in the drive housing 7, although this is not illustrated in any more detail in FIGS. 1 to 3. It is conceivable to arrange a bearing device for the shaft 2, for example, inside the drive housing 7, directly or indirectly outside the drive housing 7 or at at least one of the points at which the hollow shaft 2 is led through the drive housing 7.

FIGS. 4 and 5 show an arrangement of cylinders 1 or 1a to 1d for use in the paper industry. In this case, a paper web 22 is moved between the cylinders 1a to Id. The cylinders are arranged, stacked one above the other, and, as described, for example, in FIGS. 1 to 3, are connected to drive devices 21 or 21a to 21d. Preferably, the cylinders 1a to 1d or the drive devices 21a to 21d are held by a common machine frame 4.

The design according to the invention of a direct drive 21 for a cylinder 1 by means of a hollow shaft 2 has proved particularly advantageous when a plurality of drives 21 or 21a to 21d and cylinders 1 or 1a to 1d are arranged one above the other or else otherwise near to one another, as shown, for example, in FIGS. 4 and 5. Such an arrangement advantageously takes place with the aid of one or more frame elements 4.

Since, according to the invention, the rotor 9 is connected fixedly to the hollow shaft 2, the stator 11 is connected fixedly to the drive housing 7 or the machine frame 4 and the two devices 9 and 11 are arranged, unconnected, inside the drive device 21 so as to be separated by means of a gap 13, no undesirable transmission of vibrations or oscillations takes place in the drive device 21.

The drive according to the invention is particularly space-saving, as compared with hitherto existing hollow shaft gears, and, particularly because of its shortened form of construction, requires a substantially lower outlay in maintenance terms, since, for example, gearwheels susceptible to wear may be dispensed with and mechanical losses are reduced considerably. The design according to the invention of the drive 21 moreover allows a particularly advantageous supply of auxiliaries and fuels into the cylinder or the roller 1.

1. A direct drive for a cylinder with a hollow shaft, the direct drive comprising a drive housing, inside which are arranged at least one rotor device and at least one stator device, the stator device being connected to the drive housing, wherein the rotor device is connected directly to the hollow shaft.

2. The direct drive as claimed in patent claim 1, wherein the hollow shaft is led, free of bearings, through the drive housing.

3. The direct drive as claimed in patent claim 1, wherein the hollow shaft is mounted in the drive housing.

4. The direct drive as claimed in patent claim 1, wherein the drive housing is connected to a frame element by means of a supporting element.

5. The direct drive as claimed in patent claim 1, wherein the drive housing is connected directly to a frame element.

6. The direct drive as claimed in patent claim 1, wherein the rotor device at least partially surrounds the hollow shaft.

7. The direct drive as claimed in patent claim 1, wherein the stator device is connected directly to the housing.

8. The direct drive as claimed in patent claim 1, wherein the axis of the hollow shaft coincides with the axis of the cylinder.

9. The direct drive as claimed in patent claim 1, wherein the hollow shaft is designed in such a way that auxiliaries and/or fuels are supplied to the cylinder through the interior of the hollow shaft.

10. The direct drive as claimed in patent claim 1, wherein the hollow shaft is designed in such a way that auxiliaries and/or fuels are discharged from the cylinder through the interior of the hollow shaft.

11. The direct drive as claimed in patent claim 9, wherein the hollow shaft is designed in such a way that the direct drive is cooled by means of the auxiliaries and/or fuels to be supplied to and/or discharged from the cylinder.

12. The direct drive as claimed in patent claim 9, wherein the hollow shaft is designed in such a way that the direct drive is preheated by means of the auxiliaries and/or fuels to be supplied to the cylinder.

13. The direct drive as claimed in patent claim 1, wherein the direct drive has no bearing.

14. A direct drive for a cylinder with a hollow shaft, comprising a drive housing, inside which are arranged at least one rotor device and at least one stator device, the stator device being connected to the drive housing, wherein the rotor device is connected directly to the hollow shaft, and wherein the hollow shaft is led, free of bearings, through the drive housing.

15. The direct drive as claimed in patent claim 14, wherein the hollow shaft is mounted in the drive housing, and wherein the drive housing is connected directly to a frame element by means of a supporting element.

16. The direct drive as claimed in patent claim 14, wherein the hollow shaft is designed in such a way that auxiliaries and/or fuels are supplied to the cylinder through the interior of the hollow shaft.

17. The direct drive as claimed in patent claim 14, wherein the hollow shaft is designed in such a way that auxiliaries and/or fuels are discharged from the cylinder through the interior of the hollow shaft.

18. A direct drive for a cylinder with a hollow shaft, the direct drive comprising a drive housing, inside which are arranged at least one rotor device and at least one stator device, the stator device being connected to the drive housing, wherein the rotor device is connected directly to the hollow shaft, and wherein the hollow shaft is designed in such a way that auxiliaries and/or fuels are discharged from the cylinder through the interior of the hollow shaft.

19. The direct drive as claimed in patent claim 18, wherein the hollow shaft is designed in such a way that the direct drive is cooled by means of the auxiliaries and/or fuels to be supplied to and/or discharged from the cylinder.

20. The direct drive as claimed in patent claim 18, wherein the hollow shaft is designed in such a way that the direct drive is preheated by means of the auxiliaries and/or fuels to be supplied to the cylinder.
